(19) United States
(12) Patent Application Publication
(10) Pub. No.: US 2021/0284522 A1
(43) Pub. Date: Sep. 16, 2021

(54) METHOD FOR PREPARING HOT WATER OF VARIABLE DISCHARGE TEMPERATURE AND BEVERAGE VENDING MACHINE FOR CONDUCTING THE METHOD

(71) Applicant: Spengler GmbH & Co. KG, Gebäude, Bruchsal (DE)

(72) Inventor: Lukas URECH, Plankstadt (DE)

(21) Appl. No.: 17/263,450

(22) PCT Filed: Sep. 11, 2019
(86) PCT No.: PCT/IB2019/000990

§ 371 Date: Jan. 26, 2021

(30) Foreign Application Priority Data
Sep. 13, 2018 (DE) 10 2018 007 230.5

(51) Int. Cl. B67D 1/08; A47J 31/00; A47J 31/46

(52) U.S. Cl. CPC B67D 1/0884; B67D 1/0888; B67D 1/14; A47J 31/002; A47J 31/469; B67D 1/0895

(57) ABSTRACT

A method for preparing hot water of variable discharge temperature in a beverage vending machine, wherein the beverage vending machine contains a hot water generating system comprising a cold water supply line, an electrically heatable boiler, which has a boiler-side cold water inlet that can be connected to the cold water supply line for the supply of cold water from the cold water supply line into the boiler and a boiler-side hot water outlet for the discharge of water from the boiler that is heated to a maximum discharge temperature (ϑ_{boiler}), as well as a hot water outlet line that is connected in terms of flow to the boiler-side hot water outlet and that can be closed by at least one dispensing valve, by way of which the hot water provided with a specified discharge temperature (ϑ_{target}, ϑ_{target1}, ϑ_{target2}, ϑ_{target3}, ϑ_{target4}) for the preparation of a hot beverage can be taken from the hot water outlet line, wherein the cold water supply line can be connected alternatively to the boiler-side cold water inlet or to the boiler-side hot water outlet by way of an electrically actuatable 3/2 way valve, which, for the discharge of hot water, can be loaded with a sequence of electrical pulses, whose pulse duration (τ, τ₁, τ₂, τ₃, τ₄) is selected as a function of the specified discharge temperature (ϑ_{target}, ϑ_{target1}, ϑ_{target2}, ϑ_{target3}, ϑ_{target4}) of the hot water.

### BACKGROUND

### 1. Field of the Disclosure

The disclosure relates to a method for preparing hot water of variable discharge temperature and a beverage vending machine for conducting the method.

### 2. Discussion of the Background Art

In the preparation of hot beverages such as coffee or tea, the temperature of the water during the brewing process is a decisive factor for the quality and taste of the hot beverage. The optimal brewing temperature for coffee, for example, lies between 85° C. and 91° C., in each case depending on the type of coffee. In the preparation of black tea, herbal or fruit tea, the brewing temperature is preferably 95° C. to 100° C., and for green tea 68° C. to 91° C. White tea is preferably brewed at 55° C. to 60° C., oolong tea at 85° C. to 90° C., and jasmine tea at a temperature of 71° C. to 85° C. The optimal brewing temperature may also vary depending each time on the type of tea and may have a smaller temperature range. In order to obtain the optimal quantity of released aromas and bitter substances, a precise setting of the water temperature is accordingly desirable.

One possibility for setting the water temperature consists of adapting the through-flow rate of cold water through a continuous flow heater, so that the water exits the heater having the desired temperature. Such a solution is described in DE 10 2017 102 956 A1. Here, the water temperature is continuously measured by a measurement sensor and the through-flow rate of the water through the continuous flow heater is controlled. Through-flow heaters, however, have the disadvantage that, after the device has been awakened from sleep mode, it take a long time to heat up and reach the operating temperature, whereupon more time passes from the selection of the desired beverage until it is discharged.

An alternative to systems that are based on a continuous flow heater is represented by systems having a hot water boiler. Such a system is described in DE 10 2011 076 216 A1. In this system, the hot water boiler is also operated during the sleep mode, so that hot water is available at any point in time, and thus the time required for the preparation of a hot beverage is reduced. In contrast to a system with a continuous flow heater that delivers the water having the desired temperature, in a system having a hot water boiler, the hot water from the boiler must be mixed with the appropriate quantity of cold water in order to obtain the desired temperature. In DE 10 2011 076 216 A1, this is realized in a manner such that the corresponding quantity of cold water is intermixed with the hot water from the boiler by way of a second pump, a valve, or an aperture. In this case, however, there results the problem that the corresponding pumps, valves or apertures must be fabricated with the requisite precision for a precise temperature control, and are thereby comparatively expensive. Moreover, these do not make possible a linear through-flow control. The precise regulation of the water temperature in the case of the described device is therefore expensive and usually requires a sensor in the hot water region.

Accordingly, an object of the present disclosure is to create a method for preparing hot water of variable temperature, which enables a more precise setting of the temperature with a simultaneous reduction in production costs.

Another object of the disclosure consists in creating a beverage vending machine for conducting the method according to the disclosure.

### SUMMARY

According to the disclosure, in the method for preparing hot water of variable discharge temperature, a beverage vending machine contains a hot water generating system that comprises a cold water supply line and an electrical heatable boiler. The boiler has a cold water inlet on the boiler side that can be connected to the cold water supply line in order to supply cold water from the cold water supply line into the boiler, and a hot water outlet on the boiler side by way of which the water heated to a maximum discharge temperature ϑ_{boiler} is discharged from the boiler. To the hot water outlet on the boiler side is also connected in terms of flow a hot water outlet line that can be closed by at least one dispensing valve, by means of which the hot water that is provided with a specified discharge temperature can be taken from the hot water outlet line for preparing a hot beverage. The method is characterized in that the cold water supply line can be connected to the boiler-side cold water inlet or to the boiler-side hot water outlet alternatively by way of an electrically actuatable 3/2 way valve.

For the discharge of hot water, this 3/2 way valve is loaded with a sequence of electrical pulses, whose pulse duration is selected as a function of the specified discharge temperature of the hot water.

In the preferred embodiment of the method, in the base position of the 3/2 way valve, the 3/2 way valve connects the cold water supply line in terms of flow to the cold water supply line on the boiler side, so that when an electrical pulse is applied to the 3/2 way valve, the inlet of the 3/2 valve connected to the cold water supply line is connected in terms of flow to the second outlet of the 3/2 way valve for the duration of the electrical pulse. The latter second outlet is connected in terms of flow by way of a T-shaped or Y-shaped mixing tube or a static mixer to the boiler-side hot water outlet. In this way, at any point in time, only one flow connection is present between the cold water supply line and the hot water outlet line. Therefore, there results the advantage that no additional pump or aperture or additional valve is required in the cold water supply line of the T-shaped or Y-shaped mixing tube or the static mixer.

According to another concept lying at the basis of the disclosure, the pulse duration is determined as a function of the discharge temperature of the hot water, the temperature of the water in the cold water inlet supplied to the boiler, as well as the temperature of the water discharged from the hot water outlet of the boiler, according to the following relation:

T=T*(ϑ_{boiler}−ϑ_{target})/ϑ_{boiler}−ϑ_{supply}) wherein

τ denotes the pulse duration,
T the period duration,
ϑ_{target} the specified discharge temperature of the water,
ϑ_{supply} the temperature of the water supplied to the boiler, and
ϑ_{boiler} the maximum discharge temperature of the water in the boiler.

Correspondingly, starting from the temperature of the cold water, the temperature of the hot water in the boiler, as well as the desired discharge temperature, the pulse duration can be determined during which the second outlet of the 3/2 way valve is opened and cold water is intermixed with the water that is always heated in the boiler to a substantially constant temperature that can be set. In this way, the advantage results that, in contrast to a possible proportional valve, a nonlinear volumetric flow characteristic need not be observed, and thus an increased precision can be achieved for the setting of the discharge temperature.

According to another embodiment of the method according to the disclosure, the temperature of the water supplied to the boiler can be stored as a fixed value in an electronic memory or alternatively can be detected via a temperature sensor in the cold water supply line in order to take it into consideration in the determination of the pulse duration as a variable quantity. In this way, a temperature fluctuation of the cold water can be taken into consideration and compensated for via the formula presented above, without needing to conduct a new calibration of the system.

In order to reduce wear that occurs on the 3/2 way valve, according to another concept lying at the basis of the disclosure, it is provided that the 3/2 way valve is exclusively loaded with the sequence of electrical pulses if at least one of the dispensing valves is opened, whereby, for example, up to 7 dispensing valves can be provided, which are most preferably installed next to one another in a row.

According to another concept lying at the basis of the disclosure, at least one first and one second dispensing valve are provided, wherein, when the first dispensing valve is actuated, the 3/2 way valve is loaded with a first sequence of electrical pulses having a first pulse duration for the discharge of hot water with a first discharge temperature, and when the second dispensing valve is actuated, the 3/2 way valve is loaded with a second sequence of electrical pulses that possess a second pulse duration, in order to discharge hot water having a second discharge temperature.

According to another concept lying at the basis of the disclosure, the pulse durations corresponding to the different discharge temperatures of the water can be determined empirically, in particular by specifying a pulse duration and measuring the discharge temperature that is set, and can be stored in a memory of an electronic control device. When one of the dispensing valves is actuated, the value belonging thereto that is stored for the first or second pulse duration can be read out from the memory and supplied as an electrical signal to the electromechanically actuated 3/2 way valve. By storing the pulse duration in memory, an individual calibration can consequently be carried out for any beverage vending machine, whereby a high precision can be achieved for controlling the temperature of the water for the preparation of hot beverages.

In another embodiment of the method according to the disclosure, the pulse duration and/or the period duration can be varied during a dispensing process. By varying the pulse duration during the dispensing process, temperature fluctuations of the water can be both reduced as well as induced in a targeted manner. Thus, in a preferred embodiment, at the beginning of a dispensing process, electrical pulses with a short pulse duration can be used in order to compensate for heat losses of the water in the tubing that has cooled down after a preceding discharge process until the next hot water dispensing process. On the other hand, a variation of the period duration can be used in an advantageous way in order to reduce possible temperature fluctuations by a reduction in the period duration or to prevent wear on the 3/2 way valve by a longer period duration. In the preferred embodiment of the method according to the disclosure, the period duration is reduced at the beginning of the dispensing process in order to exactly obtain the desired temperature, and increases as soon as the volume that has been dispensed in a filling container reaches a magnitude such that the quantity of water that flows in during a period duration is small when compared to the water quantity that has already been introduced.

According to another concept of the disclosure, a beverage vending machine for conducting the method for preparing hot water of variable discharge temperature comprises a hot water generating system having a cold water supply line and an electrically heatable boiler. The boiler has a cold water inlet on the boiler side that can be connected to the cold water supply line in order to supply cold water from the cold water supply line into the boiler and a hot water outlet on the boiler side for the discharge of water heated to a maximum discharge temperature from the boiler. Moreover, to the hot water outlet on the boiler side is connected in terms of flow a hot water outlet line that can be closed by at least one dispensing valve, by means of which the hot water that is provided with a specified discharge temperature for preparing a hot beverage can be taken from the hot water outlet line into a brewing unit or a drinking vessel.

The beverage vending machine is characterized in that the cold water supply line can be connected alternatively to the boiler-side cold water inlet or to the boiler-side hot water outlet by way of an electrically actuated 3/2 way valve. For actuating the 3/2 way valve, an electronic control device is provided, by which the electrically actuatable 3/2 way valve is loaded with a sequence of electrical pulses for the flow connection of the cold water supply line to the boiler-side hot water outlet. Pulses involve electrical signals whose pulse duration is set by way of the control device corresponding to the specified discharge temperature of the hot water for a selected beverage.

According to another concept lying at the basis of the disclosure, the 3/2 way valve comprises an inlet connected to the cold water supply line as well as a first outlet connected to the boiler-side cold water inlet and a second outlet connected in terms of flow by way of a T-shaped or Y-shaped mixing tube or a static mixer to the boiler-side hot water outlet. In this case, the outlet of the T-shaped or Y-shaped mixing tube or the static mixer is connected in terms of flow by way of a line to the at least one dispensing valve. Preferably, at least one first and one second dispensing valve that can be actuated by the control device are provided. In this case, the control device loads the 3/2 way valve with a first sequence of electrical pulses that possess a first pulse duration when the first dispensing valve is actuated for the discharge of hot water having a first discharge temperature. In the same way, the control device loads the 3/2 way valve with a second sequence of electrical pulses that possess a second pulse duration when the second dispensing valve is actuated for the discharge of hot water having a second discharge temperature.

### BRIEF DESCRIPTION OF THE DRAWINGS

The disclosure will be described below with reference to the drawings on the basis of preferred embodiments. In the drawings:

FIG. 1 shows a schematic representation of the preferred embodiment of a beverage vending machine according to the disclosure;

FIG. 2a shows a schematic exemplary signal pattern of an electrical pulse P₂ in the case of a discharge temperature ϑ_{target2} of 90° C.;

FIG. 2b shows a schematic exemplary signal pattern of an electrical pulse P₃ in the case of a discharge temperature ϑ_{target3} of 70° C.;

FIG. 2c shows a schematic exemplary signal pattern of an electrical pulse P₄ in the case of a discharge temperature ϑ_{target4} of 60° C.;

FIG. 3 shows a schematic exemplary signal pattern of a sequence of pulses in which the pulse duration is varied; and

FIG. 4 shows a schematic exemplary signal pattern of a sequence of pulses in which the period duration is varied.

### DETAILED DESCRIPTION OF THE PREFERRED EMBODIMENT

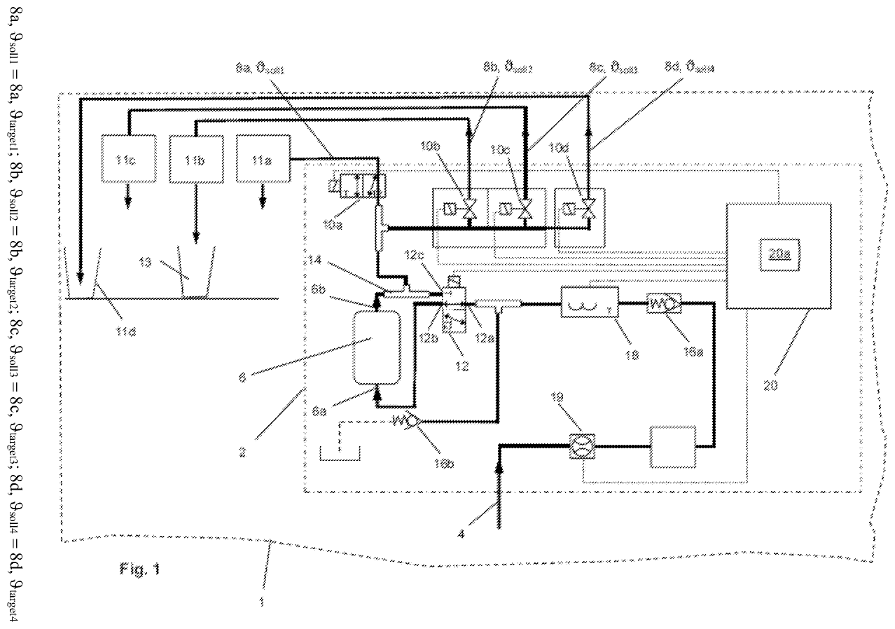

FIG. 1 shows a preferred embodiment of the beverage vending machine 1 for conducting the method according to the disclosure for preparing hot water of variable discharge temperature. This machine contains a hot water generating system 2 that comprises a cold water supply line 4 and an electrically heatable boiler 6. The boiler 6 has a cold water inlet 6a on the boiler side connected to the cold water supply line 4 in order to supply cold water from the cold water supply line 4 into the boiler 6, and a hot water outlet 6b on the boiler side by way of which the heated water is discharged from the boiler 6. To the boiler-side hot water outlet 6b is also connected in terms of flow a hot water outlet line 8, which can be closed by at least one 3/2 way dispensing valve 10a or a dispensing valve 10b, 10c, 10d, by way of which the hot water for preparation of a hot beverage 13 can be taken from the hot water outlet line 8a, 8b, 8c, 8d into the brewing units 11a, 11_{b}, 11_{c} or a drinking vessel 11d. The brewing unit 11a is, in particular, an espresso brewing unit. Prior to a dispensing process, cooled water present in the line can be drained via the 3/2 way dispensing valve 10a, since the brewing volume for espresso is small in comparison to conventional coffee. The cold water supply line 4 is connected alternatively to the boiler-side cold water inlet 6a and the boiler-side hot water outlet 6b by way of an electrically actuatable 3/2 way valve 12. In the base position, this 3/2 way valve 12 connects the cold water supply line 4 in terms of flow to the boiler-side cold water inlet 6a via the first outlet 12b of the 3/2 way valve 12, so that when an electrical pulse P is applied at the 3/2 way valve 12, the inlet 12a of the 3/2 valve connected to the cold water supply line 4 is connected in terms of flow to the second outlet 12c at the 3/2 way valve for the duration of the electrical pulse P. The latter second outlet is connected in terms of flow by way of a T-shaped or Y-shaped mixing tube 14 or a static mixer 14 to the boiler-side hot water outlet 6b. In this way, at any point in time, only one flow connection is present between the cold water supply line 4 and the hot water outlet line 8.

Between the cold water supply line 4 and the inlet 12a of the 3/2 way valve 12 are arranged a through-flow meter 19, which can be employed for determining the quantity of water that is supplied or discharged, and a temperature sensor 18, which can be used for determining the temperature of the water supplied to the inlet 12a of the 3/2 way valve 12. In addition, as shown in FIG. 1, a first spring-loaded check valve 16a can be provided between the cold water supply line 4 and the inlet 12a of the 3/2 way valve 12, in order to prevent a return flow of water into the cold water supply line 4 or into a filter, which is not discussed in more detail, when an overpressure occurs in the hot water generating system 2. Another, second spring-loaded check valve 16b that in this case operates as a draining valve or an overpressure valve may also be connected in terms of flow to the inlet 12a of the 3/2 way valve 12 via a T-branch. The dispensing valves 10a, 10b, 10c, 10d, the 3/2 way valve 12, the temperature sensor 18, as well as the through-flow meter 19 are connected to a control device 20 that contains an electronic memory 20a, in which, in particular, the temperature of the cold water detected by the temperature sensor 18 can be stored.

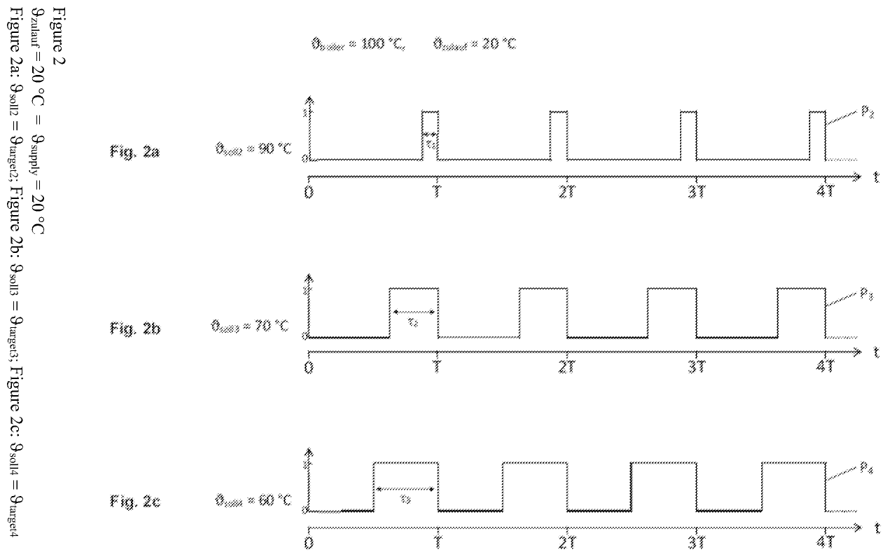

During a dispensing process, the control device 20 transmits electrical pulses P, P₁, P₂, P₃, P₄ with the pulse durations τ, τ₁, τ₂, τ₃, τ₄ to the electrically actuatable 3/2 way valve 12. As is shown in FIGS. 2a, 2b and 2c, the pulse duration τ is a function of the discharge temperature ϑ_{target} of the hot water, wherein in these figures, the temperature of the supplied water ϑ_{supply} of 20° C. and the maximum discharge temperature of the boiler 6 ϑ_{boiler} of 100° C. were selected as fixed values, by way of example. The ratio between pulse duration τ and period duration T in this case is determined on the basis of the following formula, wherein additionally, a correction factor can also be provided, by way of which the pulse duration can be reduced or increased as a function of other quantities, such as, for example, the ambient temperature.

υ=T*(ϑ_{boiler}−ϑ_{target})/(ϑ_{boiler}−ϑ_{supply})

In FIGS. 2a to 2c and the following figures, the signal value 0 represents an opening of the first outlet 12b and thus the base position of the 3/2 way valve 12, and the signal value 1 represents an opening of the second outlet 12c of the 3/2 way valve 12. With a higher discharge temperature, the pulse duration υ is correspondingly small, since only a small quantity of cold water has to be intermixed with the hot water provided in boiler 6. In contrast, the pulse duration υ at a discharge temperature of 60° C. under the selected conditions corresponds to approximately half the period duration, since the desired mixing ratio of hot and cold water amounts to 1:1.

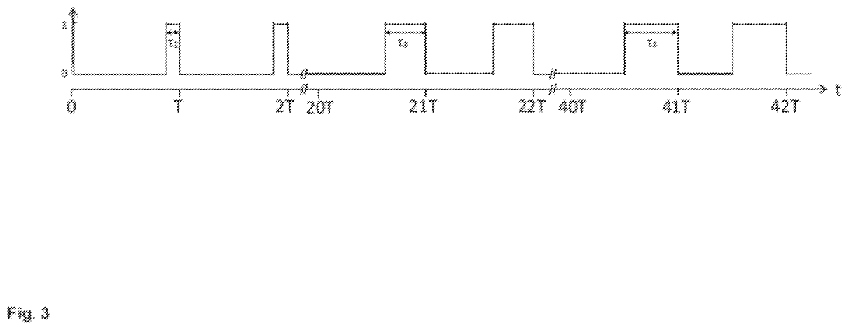

In FIG. 3, a sequence of pulses P is shown, in which the pulse duration τ is varied over an arbitrarily selected time of a plurality of periods T, as is provided in the preferred embodiment of the method according to the disclosure. At the beginning of the dispensing process, the pulse duration is shorter than toward the end of the dispensing process, which has for a consequence that the temperature of the water discharged at the beginning of the dispensing process is higher than toward the end of the dispensing process.

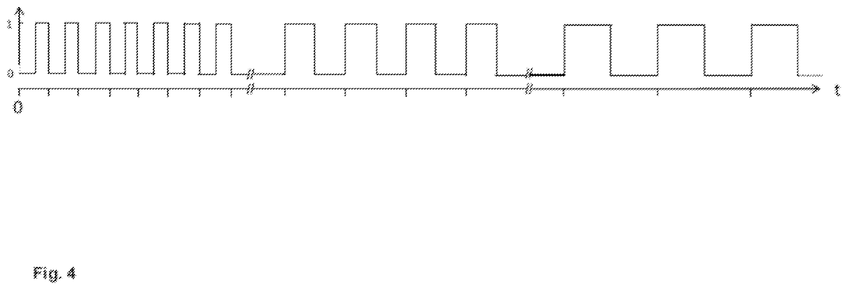

A preferred variation of the period duration T is shown in FIG. 4 by way of example. At the beginning of a dispensing process, the period duration is shortened and thus smaller quantities of hot and cold water are thus alternatively required, so that a more rapid equilibration of temperature occurs between them. Toward the end of the dispensing process, the period duration is preferably increased, for example by a factor of 3, in order to reduce wear on the 3/2 way valve 12, whose service life is limited by a maximum number of switching cycles. The period duration can amount to is at the end of a dispensing process.

### LIST OF REFERENCE CHARACTERS

1 Beverage vending machine
2 Hot water generating system
4 Cold water supply line
6 Boiler
6a Boiler-side cold water inlet
6b Boiler-side hot water outlet
8a,b,c,d Hot water outlet lines to the dispensing valves
10a 3/2 way dispensing valve
10b,c,d Dispensing valve
11a,b,c Brewing unit
11d Drinking vessel
12 3/2 way valve
12a Inlet of the 3/2 way valve
12b First outlet of the 3/2 way valve
12c Second outlet of the 3/2 way valve
13 Hot beverage
14 T-shaped or Y-shaped mixing tube or static mixer
16a,b First and second spring-loaded check valve
18 Temperature sensor
19 Through-flow meter
20 Control device
20a Electronic memory of the control device
ϑ_{boiler} Maximum discharge temperature of the water in the boiler
ϑ_{supply} Temperature of the water supplied to the boiler
ϑ_{target}, ϑ_{target1}, ϑ_{target2}, Specified discharge temperature of the water
ϑ_{target3}, ϑ_{target4}
υ, υ₁, υ₂, υ₃, υ₄ Pulse duration
T Period duration
P, P₁, P₂, P₃, P₄ Electrical pulse

1. A method for preparing hot water of variable discharge temperature in a beverage vending machine, wherein the beverage vending machine contains a hot water generating system comprising a cold water supply line, an electrically heatable boiler, which has a boiler-side cold water inlet that can be connected to the cold water supply line for the supply of cold water from the cold water supply line into the boiler and a boiler-side hot water output for the discharge of water from the boiler that is heated to a maximum discharge temperature (ϑ_{boiler}), as well as a hot water outlet line that is connected in terms of flow to the boiler-side hot water outlet and that can be closed by at least one dispensing valve by way of which the hot water provided with a specified discharge temperature (ϑ_{target}, ϑ_{target1}, ϑ_{target2}, ϑ_{target3}, ϑ_{target4}) for the preparation of a hot beverage can be taken from the hot water outlet line,
wherein the cold water supply line can be connected alternatively to the boiler-side cold water inlet or to the boiler-side hot water outlet by way of an electrically actuatable 3/2 way valve, which, for the discharge of hot water, can be loaded with a sequence of electrical pulses, whose pulse duration (υ, υ₁, υ₂, υ₃, υ₄) is selected as a function of the specified discharge temperature (ϑ_{target}, ϑ_{target1}, ϑ_{target2}, ϑ_{target3}, ϑ_{target4}) of the hot Water.

2. The method according to claim 1, wherein in the base position of the 3/2 way valve, the 3/2 way valve connects the cold water supply line in terms of flow with the boiler-side cold water inlet, and in that when the electrical pulse is applied at the 3/2 way valve, the inlet of the 3/2 valve that is connected to the cold water supply line is connected in terms of flow to the second outlet of the 3/2 way valve for the duration of the electrical pulse, the latter second outlet being connected in terms of flow by way of a T-shaped or Y-shaped mixing tube or a static mixer to the boiler-side hot water outlet.

3. The method according to claim 1, wherein the pulse duration (T) is determined as a function of the discharge temperature (ϑ_{target}) of the hot water, the temperature (ϑ_{supply}) of the water in the cold water inlet supplied to the boiler, as well as the temperature (ϑ_{boiler}) of the water discharged from the hot water outlet of the boiler, according to the following relation:
T=T*(ϑ_{boiler}−ϑ_{target})/(ϑ_{boiler}−ϑ_{supply}) wherein
t is the pulse duration,
T is the period duration,
ϑ_{target} is the specified discharge temperature of die water,
ϑ_{supply} is the temperature of the water supplied to the boiler, and
ϑ_{boiler} is the maximum discharge temperature of the water in the boiler.

4. The method according to claim 3, wherein the temperature (ϑ_{supply}) of the water supplied to the boiler is stored as a fixed value in an electronic memory or is detected via a temperature sensor in the cold water supply line and is taken into consideration in the determination of the pulse duration (T) as a variable quantity.

5. The method according to claim 1, wherein the 3/2 way valve is exclusively loaded with the sequence of electrical pulses if the at least one dispensing valve is opened.

6. The method according to claim 4, wherein at least one first and one second dispensing valve are provided, wherein, when the first dispensing valve is actuated, the 3/2 way valve is loaded with a first sequence of electrical pulses having a first pulse duration (υ₁) for the discharge of hot water having a first discharge temperature (ϑ_{target}), and when the second dispensing valve is actuated, the 3/2 way valve is loaded with a second sequence of electrical pulses that possess a second pulse duration (τ₂), in order to discharge hot water having a second discharge temperature (ϑ_{target2}).

7. The method according to claim 6, wherein the pulse durations (τ₁, τ₂) corresponding to the different discharge temperatures (ϑ_{target1}, ϑ_{target2}) of the water are determined empirically, in particular by specifying a pulse duration (τ, τ₁, τ₂, τ₃, τ₄) and measuring the discharge temperature (ϑ_{target}, ϑ_{target1}, ϑ_{target2}, ϑ_{target3}, ϑ_{target4}) that is set, and are stored in a memory of an electronic control device, and in that when the first or second dispensing valve is actuated, the stored value belonging thereto for the first or second pulse duration (τ₁, τ₂) memory and supplied to the 3/2 way valve.

8. The method according to claim 1, wherein the pulse duration (τ₁, τ₂, τ₃, τ₄) and/or the period duration T is variable during a dispensing process.

9. The method according to claim 8, wherein the pulse duration (τ₁, τ₂, τ₃, τ₄) is shortened at the beginning of a dispensing process in comparison to the end of the same dispensing process in order to compensate for heat losses, and/or in that the period duration (T) is shortened at the beginning of a dispensing process in comparison to the end of the same dispensing process in order to reduce temperature fluctuations of the hot water discharged into a filling container.

10. A beverage vending machine for conducting the method according to claim 1, containing a hot water generating system comprising a cold water supply line, an electrically heatable boiler, which has a boiler-side cold water inlet that can be connected to the cold water supply line for the supply of cold water from the cold water supply line into the boiler and a boiler-side hot water outlet for the discharge of water from the boilerthat has been heated to a maximum discharge temperature (ϑ_{boiler}), as well as a hot water outlet line connected in terms of flow to the boiler-side hot water outlet, the outlet line being able to be closed by at least one dispensing valve, by way of which the hot water provided with a specified discharge temperature (τ_{target}) for the preparation of a hot beverage can be taken from the hot water outlet line,
wherein the cold water supply line can be connected alternatively in terms of flow to the boiler-side cold water inlet or to the boiler-side hot water outlet by way of an electrically actuated 3/2 way valve, and in that an electronic control device is provided, by which the 3/2 way valve can be loaded with the sequence of electrical pulses for the flow connection of the cold water supply line to the boiler-side hot water outlet, the pulse duration (τ, τ₁, τ₂, τ₃, τ₄) of these pulses being set by the control device corresponding to the Specified discharge temperature (ϑ_{target}, ϑ_{target1}, ϑ_{target2}, ϑ_{target3}, ϑ_{target4}) of the hot water.

11. The device according to claim 10, wherein the 3/2 way valve comprises an inlet connected to the cold water supply line as well as a first outlet connected to the boiler-side cold water inlet and a second outlet that is connected in terms of flow to the boiler-side hot water outlet via a T-shaped or Y-shaped mixing tube or a static mixer, wherein the outlet of the T-shaped or Y-shaped mixing tube or the static mixer is connected in terms of flow by way of a line to the at least one dispensing valve.

12. The device according to claim 10, wherein at least one first and one second dispensing valve that can be actuated by the control device are provided, and in that when the first dispensing valve is actuated, the control device loads the 3/2 way valve with a first sequence of electrical pulses that possess a first pulse duration (T₁) for the discharge of hot water having a first discharge temperature (ϑ_{target1}), and
when the second dispensing valve is actuated, the control device loads the 3/2 way valve with a second sequence of electrical pulses that possess a second pulse duration (T₂) for the discharge of hot water having a second discharge temperature (ϑ_{target2}).

13. The method according to claim 1, wherein in a base position of the 3/2 way valve, the 3/2 way valve connects the cold water supply line in terms of flow with the boiler-side cold water inlet, and in that when an electrical pulse is applied at the 3/2 way valve, the inlet of the 3/2 valve that is connected to the cold water supply line is connected in terms of flow to the boiler-side hot water outlet for the duration of the electrical pulse).

14. The device according to claim 11, wherein at least one first and one second dispensing valve that can be actuated by the control device are provided, and in that when the first dispensing valve is actuated, the control device loads the 3/2 way valve with a first sequence of electrical pulses that possess a first pulse duration (T₁) for the discharge of hot water having a first discharge temperature (ϑ_{target1}), and
when the second dispensing valve is actuated, the control device loads the 3/2 way valve with a second sequence of electrical pulses that possess a second pulse duration (T₂) for the discharge of hot water having a second discharge temperature (ϑ_{target2}).
